(19) United States
(12) Patent Application Publication
(10) Pub. No.: US 2012/0307024 A1
(43) Pub. Date: Dec. 6, 2012

(54) Simulated product container with video message delivery system

(76) Inventor: James P. Howes, Wilton, CT (US)

(21) Appl. No.: 13/134,276

(22) Filed: Jun. 2, 2011

(51) Int. Cl. H04N 7/18

(52) U.S. Cl. 348/61; 348/E07.085

(57) ABSTRACT

A simulated product container, which is used as a prize award container, has a container shell and a video message delivery system. The video message delivery system has a lid that can be an actual lid of an actual product container. The video message delivery system has a body for insertion into an open end of the container shell, a tab and a tab opening mechanism to allow a consumer to open the simulated product container. When the simulated product container is opened, the tab is pushed into the interior of the body to reveal an opening in the lid. When light enters into the interior of the body, a light sensor activates a circuit so as to display a video image on a video display. A tab deflection mechanism deflects the tab so as to allow an unobstructed view of the video display through the opening.

### TECHNICAL FIELD

The present invention relates to simulated product containers constructed for secretly retaining a video message delivery system and, more particularly, to simulated product containers for any product, including liquid, semi-liquid, moist products, constructed for secretly retaining the video message delivery system either independently or in conjunction with an actual prize award while being indistinguishable from non-prize bearing product containers. The invention is also directed to a voice message delivery system for use in making a simulated product container.

### BACKGROUND OF THE INVENTION

The use of various promotional enhancements for increasing the sale of particular products is commonly employed by manufacturers or distributors for a wide variety of products. These promotional enhancements take on a variety of forms, all for the purpose of increasing product sales.

One of the promotional methods often employed by manufacturers is the inclusion of a prize in either every product container or in selected containers. In order to attain greater market share for product sales, manufacturers and distributors have utilized a variety of different promotional themes in order to generate added sales for their particular products. In doing so, the premium or prize-like promotion has progressed from inexpensive give-aways packed in every product bearing container to expensive prize awards which are packed in selected containers, which containers are randomly distributed with non-prize bearing containers.

Due principally to the difficulties of contamination, product degradation, or prize degradation, prior art incentive programs have typically not been employed by manufacturers or distributors of wet or moist products. As a result, liquid food products such as soda, water, beer, juice, and the like and moist food products, such as yogurt, cottage cheese, sour cream, jellies, jams, peanut butter, dips, canned fruits, vegetables and the like, have been incapable of employing promotional sales incentives.

In addition, other wet or moist consumable goods such as detergents, soaps, bleaches, automotive oils, polishes and the like have been unable to employ prior art product promotional techniques. As a result of this inability, these manufacturers or distributors have been incapable of employing an effective product sales incentive in order to generate increased interest and sales of their respective products.

In applicant's prior U.S. Pat. No. 5,099,232, a prize holding container assembly is disclosed in which an audio or visual prize message delivery system is mounted within a product container which is activated upon opening of the product. It is disclosed therein that the visual prize related message delivery system could comprise one or more LEDs or other light source to provide a light display ranging from a single blinking light as the sole message to a fully integrated multicolor illumination display. Thus, although a visual message delivery system is discussed in my prior patent, no disclosure is directed to a video message delivery system.

### OBJECTS OF THE INVENTION

An object of the present invention is a simulated product container including a video message delivery system.

It is a further object to provide such a video message delivery system which has a body that can be mated to a container shell so as to form a simulated product container.

A still further object of the present invention is to provide a video message delivery system incorporating a stay-on tab opening mechanism configured to cooperate with a tab associated with a lid, so that upon opening the tab, a tab deflection mechanism is configured to deflect the tab to a position so as to not visually impair viewing of a video display forming part of the video message delivery system through an opening in the lid.

Other objects of the invention will be clear from the following description.

### SUMMARY OF THE INVENTION

By employing the present invention, the failure of prior art systems to provide added excitement to the thrill of winning a prize award is achieved by a video message delivery system, including a video message delivery system used with containers of liquid, semi-liquid or moist products. In one embodiment of the present invention, a video message delivery system is mounted within a product container shell to form a simulated product container for being activated upon the opening of the simulated product container. In this way, a prize award video message can be made informing the consumer (the person who opens the simulate product container) of the actual prize that has been won. Alternatively, the video message delivery system can incorporate a video message to accompany the winning of a prize which is actually mounted within the simulated product container. In this way, the thrill and excitement of winning a prize award is further enhanced and made more important and significant. The video message delivery system may include one or more speakers and audio control to provide a video message with an accompanying audio message (sometimes referred to as a multimedia message).

In an embodiment of the present invention, a simulated product container is employed to house the video message delivery system either individually or in association with an actual prize award within the simulated product container. Regardless of which configuration is employed, the simulated product container is constructed to be identical to the genuine (actually, conventional) product container in all consumer discernible respects prior to the opening of the simulated product container. In this way, the simulated product container of the present invention is indistinguishable from a conventional product container by external analysis. As a result, the simulated product container can be randomly distributed with genuine product containers with complete assurance that the simulated product container cannot be purposefully pre-selected by a consumer in order to obtain the prize award contained or announced therein.

In one aspect of use of the present invention, simulated product containers are randomly distributed with genuine, product bearing containers. Only upon opening the simulated product container by a consumer is the consumer aware that a prize award has been won, with this embodiment of the present invention providing the consumer with a prize award related video message as either the means for announcing the prize award, or as the means for accompanying the actual prize award as a further enhancement to the moment when the consumer realizes that a prize award has been won.

Regardless of which embodiment of the present invention is employed, a stay-on tab or other closure mechanism prevents inadvertent or unwanted activation of the video message delivery system prior to opening the simulated product container in the normal fashion as if the product were to be dispensed therefrom. In this way, any consumer seeking to determine a prize bearing simulated product container from other actual product bearing containers will be unable to activate the video message delivery system while on the store shelves, without actually destroying the integrity of the simulated product container.

Thus, the present invention for the first time allows the ability for manufacturers and distributors of liquid, semi-liquid, or moist products to employ this unique incentive promotion with a video message delivery system. Regardless of whether the products are for human consumption or for other purposes, such as liquid detergents, soaps, bleaches, washing compositions, automotive oils, lubricants, and the like, these wet or moist products can also employ the teaching of the present invention in order to attain the unique prize incentive promotion for enhancing product sales. Depending upon the type of wet or moist product being sold, the unique product construction of the present invention can be employed along with the actual product.

Thus, the present invention in one embodiment is directed to a simulated product container used as a prize-winning container in order to promote a commercial product. The simulated product container is virtually indistinguishable from the non-prize bearing product containers. The simulated product container includes a voice message delivery system that includes a body dimensioned for insertion into the open end of a container shell. The video message delivery system also has a lid to allow a consumer to open the simulated container in a manner essentially the same as any non-prize bearing product container. The lid may have a stay-on tab opening mechanism which is used to open the simulated product container. When light enters into the interior of the simulated product container through the opening, a light sensor (e.g., a light sensor switch) triggers a controller to present a video message on an accompanying video display alone or in conjunction with an audio message emanating from one or more associated speakers or other sound producing device. The video message can be a prize award announcement message or other product promotion message.

The lid can be identified to the lid used in an actual product container.

Another embodiment of the present invention is a video message delivery system for mating with a container shell. The video message delivery system includes:

a body dimensioned for insertion into an open end of a container shell;

a lid disposed on the body, the lid configured to have an opening,

a tab having a first tab position to conceal the opening and operable to reveal said opening and thereby to allow light to enter into an interior of the body through the opening, and

a tab opening mechanism configured to cause the tab to move from the first tab position into the interior of the body so as to reveal said opening;

a video display disposed in the interior of the body;

a circuit configured for receipt of electrical power and configured to display a video message on the video display; and

a light sensor configured to sense light entering the interior of the body and to cause the circuit to display a video message on the video display in response to light entering the interior of the body.

A further embodiment of the present invention is a video message delivery system as described above, further wherein a tab deflection mechanism positioned on the inner (under) side of the lid, the tab deflection mechanism having a mechanical arm pivotably mounted in the interior of the body and a spring disposed in relation to the mechanical arm and configured to provide an urging force to the mechanical arm so as to assist movement of the tab to a second tab position allowing for a clear (unobstructed) view of the video screen when the tab opening mechanism opens the simulated product container.

Another embodiment of the present invention is such a video message delivery system further comprising at least one speaker or sound producing device and wherein the controller is further configured to cause the at least one speaker to generate an audio message along with the video message in response to light entering the interior of the body.

According to the present invention, the mechanical arm of the tab deflection mechanism is operable to move from a first arm position to a second arm position so as to deflect the tab away from the opening; wherein the tab deflection mechanism further comprises a mechanical stop for keeping the mechanical arm in the first arm position when the tab is in the first tab position, wherein when the tab is pushed by the tab opening mechanism to reveal the opening, the tab is configured to cause the mechanical arm to disengage from the mechanical stop so as to allow the mechanical arm to change from the first arm position to the second arm position, thereby deflecting the tab to the second tab position.

According to one embodiment of the present invention, a spring is disposed in relationship to the mechanical arm, the spring configured to provide a deflecting force to the mechanical arm so as to deflect the tab to the second tab position.

According to one embodiment of the present invention, the mechanical arm is operable in a first arm position and a different second arm position for keeping the tab in the second tab position.

An embodiment of the present invention is a video message delivery system having an electronic circuit comprising a processor and a memory having a program, the processor configured to cause the video display to display the video message based on the program and to optionally cause an audio message to be played through at least one speaker.

According to one embodiment of the present invention, the processor is configured to cause the video message and, if present, the audio message, to terminate when the light is blocked from entering into the interior of the body; and to cause the message(s) to restart when the light is allowed to enter the opening after such blocking.

According to one embodiment of the present invention, the video message delivery system also has at least one speaker configured to announce an audio message when the video display is caused to display the video image; an electronic circuit comprising a processor and a memory storing a program, the processor configured to cause the video display to display the video message based on the program; and to cause the speaker to annunciate an audio message in conjunction with the video message; and a battery arranged to provide electrical power to the electronic circuit and the video display.

According to one embodiment of the present invention, the simulated product container comprises a product container shell with an inner surface and the body of the video message delivery system comprises an enclosed surface, and at least part of the enclosed surface of the body is spaced from the inner surface of the product container shell for providing a space between the container shell and the body, so that at least part of this space can be filled with a liquid to simulate an actual product container in terms of weight, feel and sound.

A further embodiment of the present invention is

a container shell having an outer surface substantially identical in appearance to a product bearing shell of a product container normally employed for a product, and having an interior surface configured for providing the simulated product container with a sound, weight and feel of the product normally contained therein;

a video message delivery system comprising:
a body dimensioned for insertion into an open end of the container shell;
a lid disposed on the body, the lid configured to have
an opening,
a tab having a first tab position to conceal the opening and operable to reveal said opening and thereby to allow light to enter into an interior of the body through the opening, and a tab opening mechanism configured to cause the tab to move from the first tab position into the interior of the body so as to reveal said opening;

a video display disposed in the interior of the body,
a circuit configured to receive of electrical power and configured to display a video message on the video display, and
a light sensor configured to sense light entering the interior of the body and to cause the video to display a video message on the video display in response to light entering the interior of the body; and

means positioned in a space between an interior surface of the container shell and an outer surface of the body for providing the simulated product container with the sound, weight and feel of a product normally contained therein.

Another embodiment of the present invention is a method for displaying a video message inside a simulated product container comprising:

moving a tab formed in the lid of the simulated product container so as to reveal an opening in the lid;

sensing light entering the interior of the simulated product container and in response thereto, generating a video message for viewing through the opening formed in the lid.

A further embodiment of the present invention is such a method wherein the moving of the tab so as to reveal the opening in the lid causes the tab to enter into an interior of the simulated product container, the method further comprising deflecting the tab after the tab has entered into the interior of the simulated product container so as to maintain the tab in a tab position so as to allow for unobstructed viewing of the video message on the video display through the opening.

### BRIEF DESCRIPTION OF THE DRAWINGS

FIG. 1 shows a video message delivery system, according to the present invention dimensioned for forming a simulated product container upon mating with a product container shell.

FIG. 2 is a cross-sectional view of the simulated product container according to the present invention.

FIG. 3 is another cross-sectional view showing the interior of the video message delivery system.

FIG. 4 is an exploded view of the video message delivery system, according to the present invention.

FIGS. 5A-5C are cross-sectional views taken along lines 5-5 of FIG. 2, and show the lid of the video message delivery system with different tab positions, as well as the tab deflection mechanism.

FIGS. 6A, 6B, and 6C are partial cross-sectional views of an alternative embodiment of the video message delivery system for storage of an actual prize award; with FIG. 6C taken along line 6C-6C shown in FIG. 6A.

FIG. 7 is a block diagram showing the video circuit according to one embodiment of the present invention.

### DETAILED DESCRIPTION OF EMBODIMENTS OF THE INVENTION

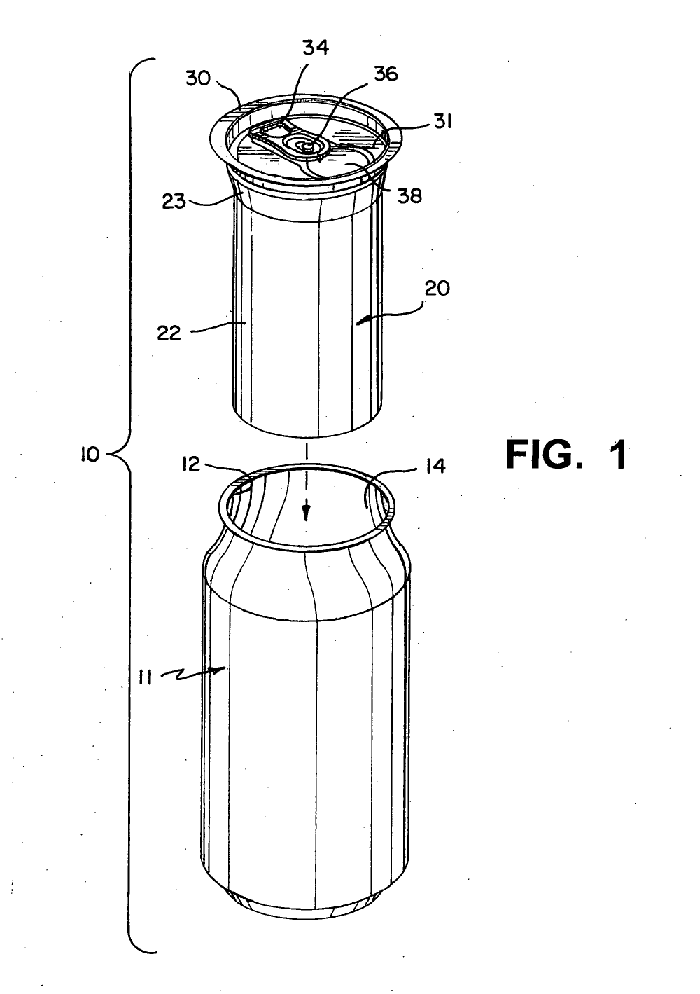

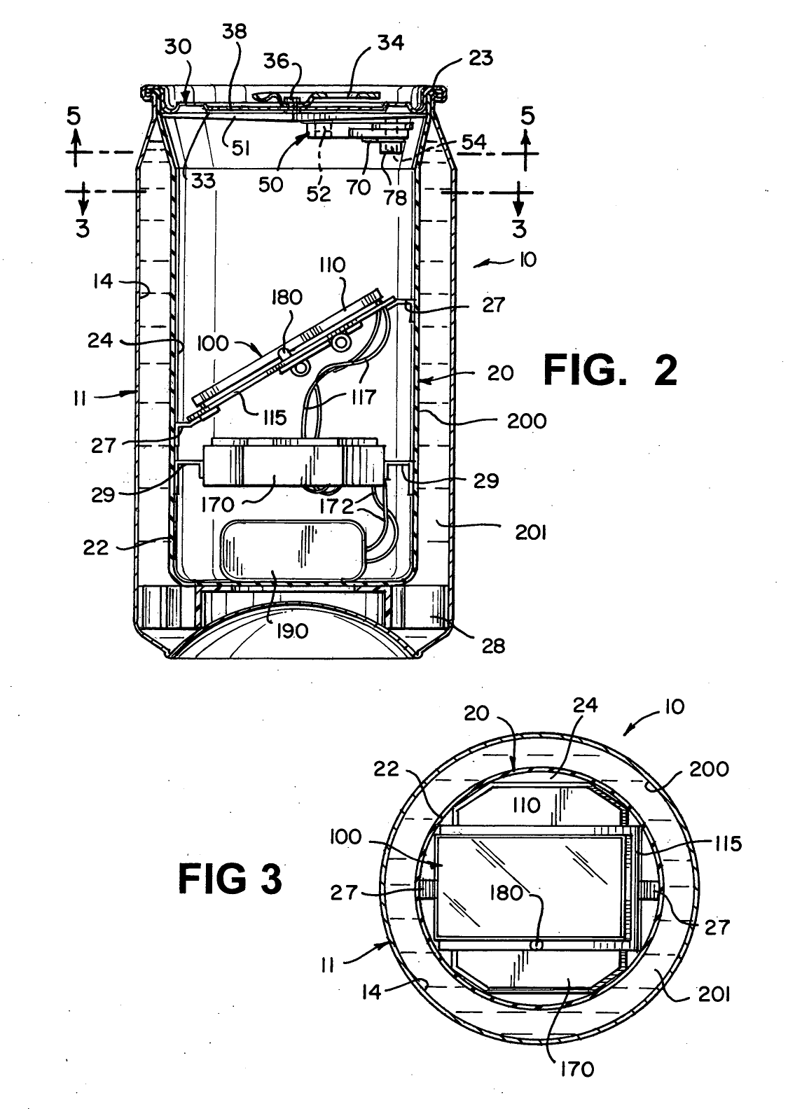

In FIGS. 1-4, a simulated product container 10 of the present invention is formed from a container shell 11 and a video message delivery system 20. As seen in FIGS. 1 and 2, the simulated product container 10 has the same overall appearance as a conventional (actual) product holding container which the simulated product is intended to emulate. In this regard, as seen in FIG. 2, a space 200 between inner surface 14 of container shell 11 and a body 22 of the video message delivery system is typically filled with a liquid 201 having properties corresponding to that in an actual product container so that the overall feel of the simulated product container is substantially identical to an actual product container. In this manner, if the simulated product container is grouped with actual product containers, a person is unable to determine the presence of a simulated product container due to its appearance, form, weight and sound (e.g., that associated with tapping the container) being substantially the same as the actual product containers.

Although simulated product container 10 is depicted as a conventional liquid holding can, typically employed for beverages, such as soda, beer, juices, etc., the simulated product container 10 contains no consumable liquid. Instead, the simulated product container houses the video message delivery system 20 as will be explained in detail below. This video message delivery system 20 is configured to automatically be activated upon opening of the simulated product container by operation of the stay-on tab opening mechanism 34, immediately informing the consumer about some video message, such as a prize or some other award, as well as potentially providing information concerning a prize contained with the simulated product container.

In order to attain the characteristics of an actual product container, the simulated product container 10 comprises an outer container shell 11 which is identical to the container (can) shell employed by the manufacturer or bottler for the consumable liquid-holding product container (can) which the simulated product container 10 is constructed to represent. However, instead of being sold with a consumable liquid housed therein, space 200 inside the simulated product container typically contains a non-consumable liquid 201 identical in weight, feel, and sound to the consumable liquid. In addition, the simulating liquid 201 within space 200 is sealingly enclosed within space 200 to prevent its accidental use.

More particularly, as seen in FIG. 1, one embodiment of the present invention is therefore a video message delivery system 20 for insertion into an open end 12 of a container shell 11 to form a simulated product container 10 that effectively simulates a product bearing container.

As shown in FIG. 1, the video message delivery system 20 has a body 22 and a lid 30. The body 22 has a cylindrical shell dimensioned to be inserted into the open end 12 of the container 10. With the design of the lid 30 and container shell 11, the simulated product container 10 looks, feels, and sounds like a can of soda, for example. The lid and/or the container shell can be identical to that used in an actual product container.

FIG. 2 is a cross-sectional view of the simulated product container 10, according to one embodiment of the present invention. As shown in FIG. 2, the lid 30 of the video message delivery system 20 is dimensioned to fit the top part 23 of the body 22 so that its interior space 24 is light-tight. As such, light is prevented from entering into the interior space 24 of the body 22. In the interior space of the body 22, there is a video display system 100 securely mounted to the body 22, such as by brackets 27. The video display system 100 has a video display 110 and a circuit 115 for driving the video display 110. The video display 110 is configured to display one or more video images. A light sensor 180, also disposed in the interior space of the body 22, can be mounted to the video display system 100. The light sensor 180 is used to trigger displaying a video message on the video display 110 in response to light entering into the interior space of the body 22. An audio producing device, such as a speaker 170 mounted to body 22 by brackets 27, for example, may optionally be used to provide an audio message under control of circuit 115 via wires 117 in conjunction with the video message. A battery 190 also mounted in body 22 is used to provide electrical power to the video display system 100 and the optional speaker 170. The battery may also be mounted to the video display system 100, or elsewhere within body 22. According to one embodiment of the present invention, the video message delivery system 20 has a base support 28 to support body 22 relative to container shell 11.

FIG. 3 is a cross-sectional view of the simulated product container 10 taken along line 3-3 of FIG. 2, showing the locations of the video message delivery system 20, including video display system 100, video display 110, and the light sensor 180.

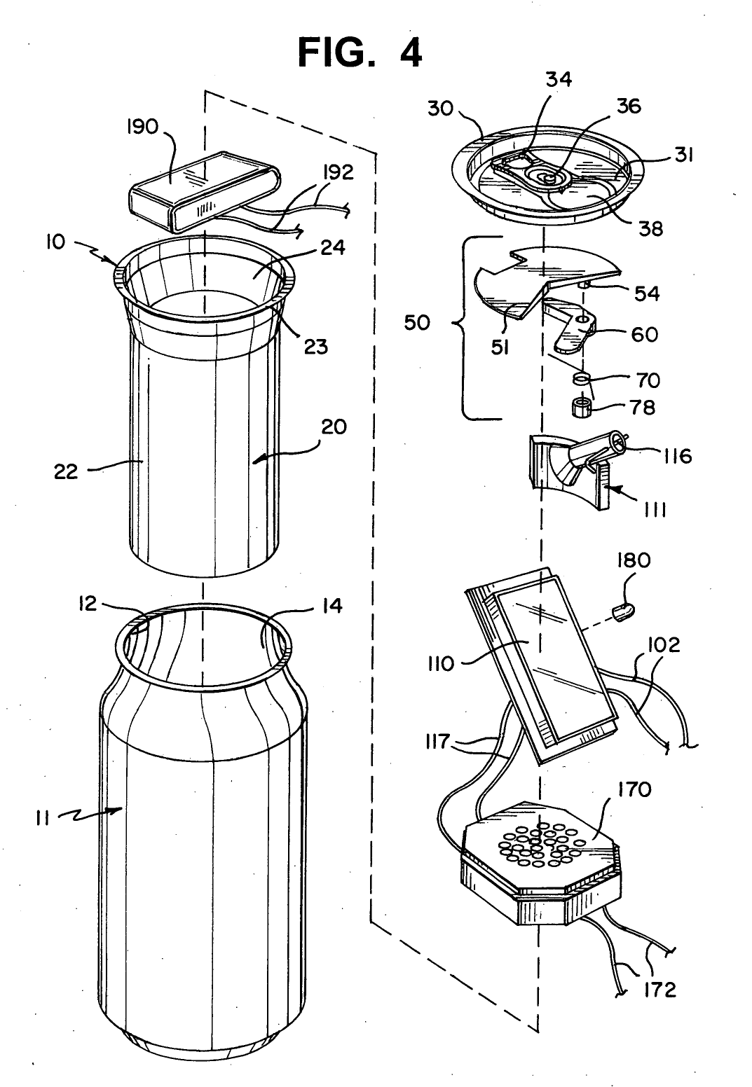

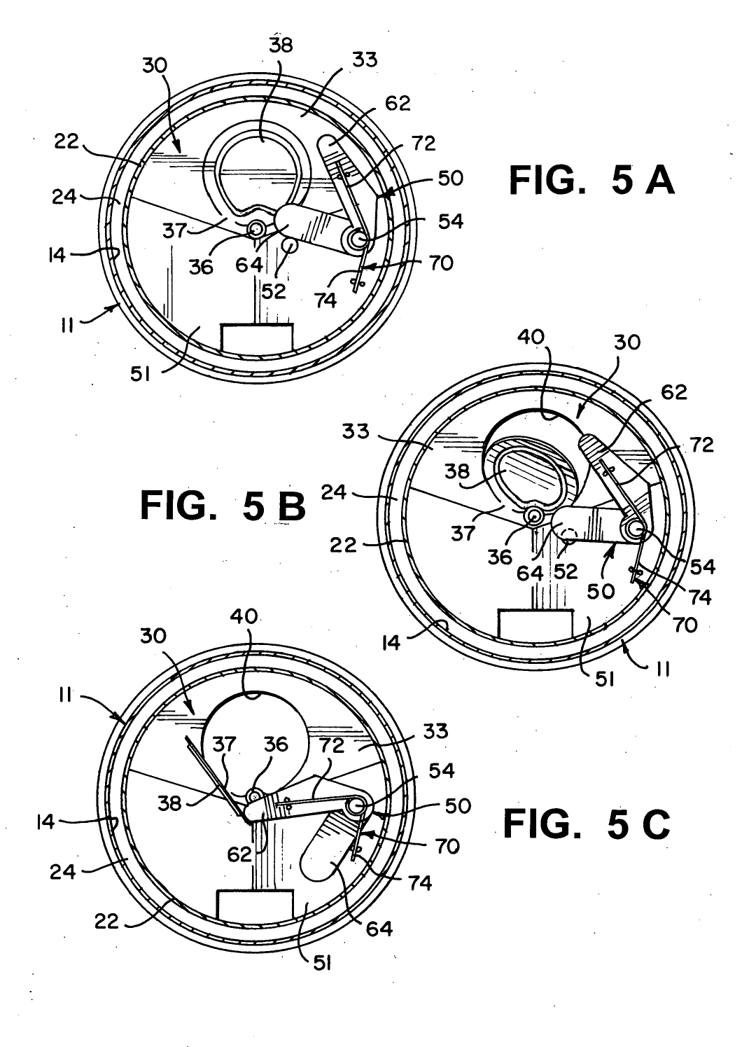

FIG. 4 is an exploded view of the simulated product container according to one embodiment of the present invention. As shown in FIG. 4, the container shell 11 has an open end 12. Body 22 is substantially a cylindrical body having a flared top portion 23 dimensioned to fit the open end 12 of the container shell 11. In the interior space 24 of the body 22, electrically conducting wires 192 on the battery 190 are connected to the electrically conducting wires 172 on the speaker 170 and the electrically conducting wires 102 on the circuit 115. It is understood that the light sensor 180 is electrically connected to the video message delivery system 20. As shown in FIG. 4, the lid 30 has an outer side 31 and an inner or under side 33 (see FIGS. 5A-5C), with the inner side facing the interior space 24 of the insert body 22. On the outer side 31 of lid 30, a stay-on tab opening mechanism 34 is mounted to lid 30 via pin or rivet 36. The stay-on tab opening mechanism is constructed to push tab 38 downward toward the interior 24 of body 22 and thereby allowing a consumer to “open” the simulated container in a manner substantially identical to a conventional beverage container using a conventional stay-on tab. On the inner side of the lid 30, a tab deflection mechanism 50 is used to insure that when tab 38 is inserted into the container by the stay-on tab opening mechanism 34, that the tab does not obscure viewing of the display screen 110 through opening 40 from in lid 30. This obscuring of display 110 by tab 38 when the stay-on tab opening mechanism 34 is employed to open the simulated container is best seen in FIGS. 5A and 5B, with FIG. 5A showing the container in the un-opened state and FIG. 5B showing the tab after the stay-on tab opening mechanism has been used, but prior to deflection by the tab deflection mechanism. FIG. 5C shows the additional deflection of the tab by the tab deflection mechanism so as to allow for a substantially unobscured view of display 110 through opening 40.

This tab deflection mechanism 50 includes a mounting plate 51 and a mounting pin 54 for pivotably mounting a mechanical arm 60 to the mounting plate. A spring 70, which is mounted in relationship to the mechanical arm 60, is used to provide an urging force to the mechanical arm 60 as illustrated in FIGS. 5A to 5C. A spring cap 78 is used to keep the spring 70 in place.

In more detail, FIGS. 5A to 5C are cross-sectional views of the video message delivery system 20 showing the inner (under) side of the lid 30. As shown in FIGS. 5A-5C, the mounting plate 51 is securely attached to the inner side 33 of the lid 30. The mounting plate 51 has an arm mounting pin 54 for pivotably mounting the mechanical arm 60 and the spring 70. The mechanical arm 60 has a first arm part 62 and a second arm part 64. The spring end 72 of the spring 70 is attached to the first arm part 62 of the mechanical arm 60 and the other spring end 74 of the spring 70 is attached to the mounting plate 51. The spring ends 72, 74 are stretched apart such that the spring 70 is configured to provide an urging force to the first arm part 62 of the mechanical arm 60, urging the mechanical arm 60 to rotate toward the spring end 74.

FIG. 5A shows the lid 30 when the simulated product container 10 has not been opened and the tab 38 is thus in an unopened position. As shown in FIG. 5A, the mounting plate 51 has a stop 52 affixed thereto to keep the mechanical arm 60 from rotating. When the tab 38 is in the unopened position, the tab 38 prevents light from entering into the interior space 24 of the insert body 22 (see FIG. 2). The tab 38 can be an integral part of the lid 30, for example.

FIG. 5B shows the lid 30 when the simulated product container is opened by the stay-on tab opening mechanism 34. As shown in FIG. 5B, the tab 38 is pushed inward toward interior 24 of body 22 (see FIG. 2) and an opening 40 is thus formed (revealed) on lid 30. Although the tab 38 is pushed away from the opening 40, the tab 38 is still hingedly attached to the lid 30 by a hinge 37. As the tab 38 is pushed toward the interior of the insert body 22, the lid 30 is lifted in the region around pin 36 (pin 36 which secures the tab opening mechanism to lid 30). This lifting also lifts stop 52 relative to the second arm part 64, causing the second arm part 64 to disengage from stop 52. As such, the mechanical arm 60 is able to rotate toward the spring end 74 under the urging force of the spring 70.

FIG. 5C shows the lid 30 when the mechanical arm 60 has moved away from its restrained position as shown in FIG. 5B to its final position. As the mechanical arm 60 moves toward its final position, the first arm part 62 is configured to deflect tab 38 away from the opening 40 thereby allow an unobstructed view through opening 40 toward video display 110. Thus, the tab deflection mechanism 50 allows a person to see video display 110 in a substantially unobstructed manner through opening 40.

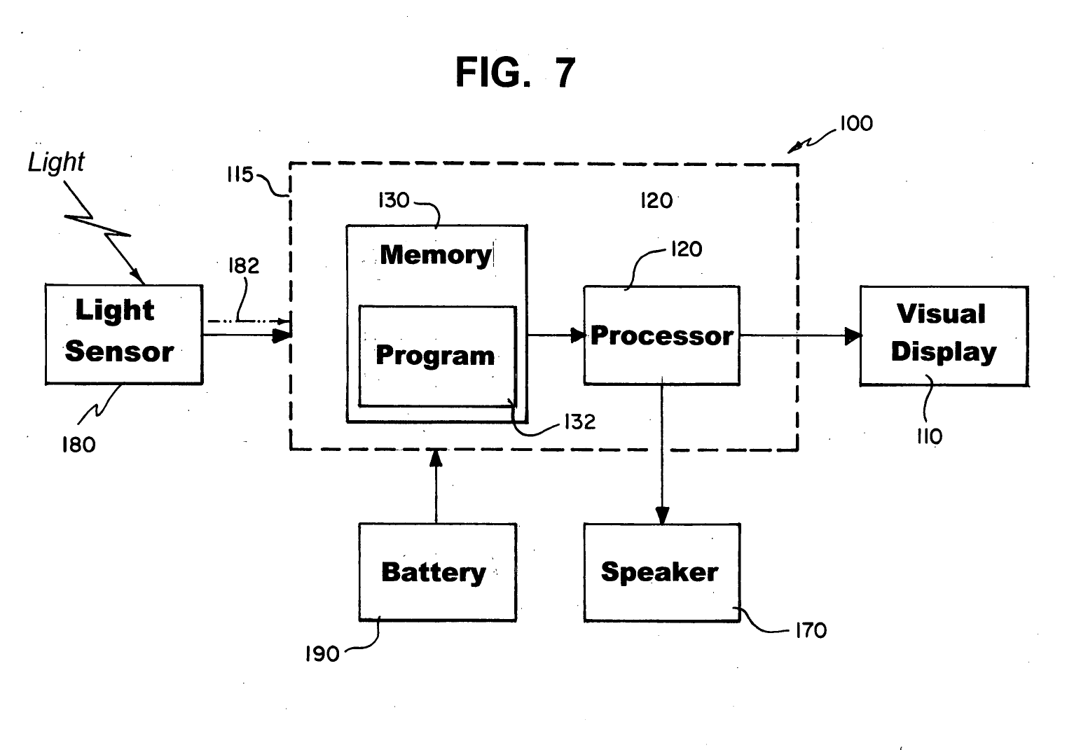

When the opening 40 on the lid 30 is revealed, light is able to enter into the interior 24 of the body 22 (see FIG. 2). In response to the light entering the interior of the body, the light sensor 180 is configured to provide a signal 182 to the circuit 115, as shown in FIG. 7. The signal 182 is configured to activate the video message delivery system 20. As a result, the processor 120 in the circuit 115 causes the video display 110 to display a video message based on the program 132 stored in a memory 130. The processor 120 is also configured to optionally cause the speaker (or other sound producing device) 170 (if present) to provide an audio message. Thus, as the tab 38 is deflected away from the opening 40 by tab deflection mechanism 50 as shown in FIG. 5C, the video message displayed on the video display 110 can be clearly viewed, without visual obstruction by tab 38.

As the simulated product container 10 is used to play a video message announcing a prize award when the consumer opens the simulated container, the speaker 170 is optionally configured to provide an audio message to similarly announce the prize award, for example. The video and optional audio message can also be used to promote the product of the other actual product containers to which the simulated product container is associated (such as in a six-pack configuration of product containers). Likewise, the video message displayed on the video display 110 can be used to show the prize award and a code for claiming the prize award (such as a monetary prize, for example). The video message in optional combination with an audio message can also be used to inform the consumer of one or more ways to claim the prize award. For example, if the video message includes an image of a code label, the consumer can be instructed to call a designated telephone number and read the code label to a telephone operator. The consumer can also be instructed to go to a website to enter the code label to claim the prize award online. The code label can be a series of numbers and or letters such as 1390343AB, for example.

The video display 110 can be a liquid-crystal display (LCD) panel, a light-emitting display (LED) panel or the like. The video message displayed on the video display 110 can be in black-and-white or color.

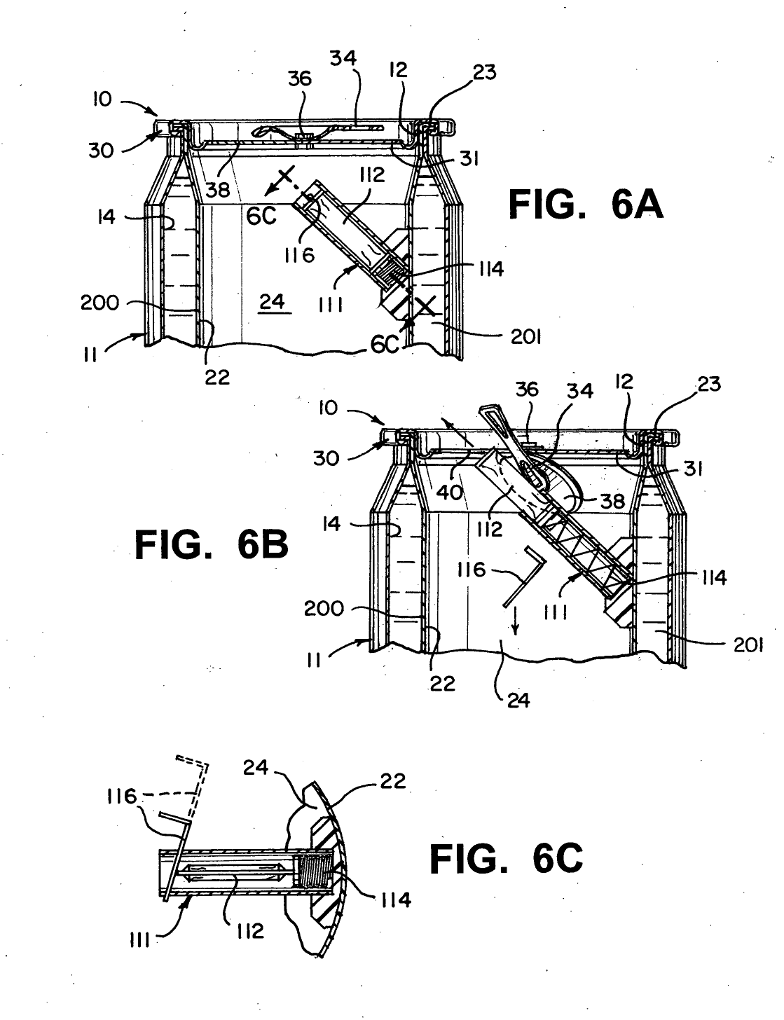

FIGS. 6A, 6B, and 6C show an alternative embodiment of the present invention in which the video display system 100 further comprises a prize holder 111 for storing a prize award 112 and configured so as to allow the prize award to be retrieved from the simulated product container 10 when the stay-on tab opening mechanism 34 opens the tab 38 shown in FIG. 6B. A spring 114 or other urging device can be used for retrieving the prize award. Other configurations of the prize holder 111 could be used for storing a prize award within the interior 24 of the video message delivery system 20. FIGS. 6B and 6C show that a pin or arm 116 can be released by the tab opening mechanism (the pin can be released and freed as shown in FIG. 6B). Other release mechanisms could be used as disclosed in my U.S. Pat. No. 5,099,232. This embodiment can be used in conjunction with the tab deflection mechanism shown in FIGS. 5A-5C.

According to the one embodiment of the present invention, the processor 120 is configured to repeat a video message (and optional audio message) a pre-determined number of times after the simulated product container is opened. For example, the video message is programmed to repeat two or more times while the image remains on the video display. Furthermore, the video message can be one or more sequences of video images and the processor 120 can be configured to repeat these one or more sequences for a pre-determined number of times, such as two or more times.

According to one embodiment of the present invention, during or after presentation of the video message, the consumer may block the opening 40 of the lid 30 to substantially prevent light from entering into the interior of the insert body 22. As a result, the light sensor 180 does not sense the entering light. The video message delivery system is then switched off until the light sensor 180 senses the light again. When the opening 40 is unblocked and light is allowed to enter into the interior 24 of the insert body 22 again, the light sensor 180 provides another signal to start the video (plus optional audio) message.

Thus, what has been described is a simulated product container having a video message delivery system contained therein which provides for presentation of a video message upon opening of the simulated container. The video message may be presented in conjunction with an audio message and may have other features, including repetition of the video message and/or audio message.

A tab deflection mechanism can be used in the video message delivery system to insure that upon opening of the simulated product container, the tab of the simulated product container does not obscure viewing of the video display of the video message delivery system through the opening formed in the simulated product container.

It will thus be seen that the objects set forth above among those made apparent from the preceding description, are efficient attained and, since certain changes may be made in the above products, without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed is:

1. A video message delivery system, comprising:
a body dimensioned for insertion into an open end of a container shell;
a lid disposed on the body, the lid configured to have
an opening,
a tab having a first tab position to conceal the opening and operable to reveal said opening and thereby to allow light to enter into an interior of the body through the opening, and
a tab opening mechanism configured to cause the tab to move from the first tab position into the interior of the body so as to reveal said opening;
a video display disposed in the interior of the body;
a circuit configured for receipt of electrical power and configured to display a video message on the video display; and
a light sensor configured to sense light entering the interior of the body and to cause the circuit to display a video message on the video display in response to light entering the interior of the body.

2. The video message delivery system according to claim 1, further comprising a tab deflection mechanism having a mechanical arm pivotably mounted in the interior of the body, the mechanical arm configured to deflect the tab to a second tab position by contacting the tab when the tab is in the interior of the body so as to provide for a substantially unobstructed view of the video message on the video display through said opening.

3. The video message delivery system according to claim 2, wherein the tab deflection mechanism further comprises a spring disposed in relationship to the mechanical arm, the spring configured to provide a force to the mechanical arm so as to deflect the tab to the second tab position and maintain the tab in said second position.

4. The video message delivery system according to claim 3, wherein the mechanical arm is operable in a first arm position and a second arm position to deflect the tab to the second tab position, said tab deflection mechanism further comprising:
a mechanical stop configured to keep the mechanical arm in the first arm position when the tab is in the first tab position, wherein the tab opening mechanism is configured to cause the mechanical arm to disengage from the mechanical stop so as to allow the mechanical arm to move from the first arm position to the second arm position when the tab opening mechanism causes the tab to move from the first tab position into the interior of the body.

5. The video message delivery system according to claim 4, wherein the tab deflection mechanism further comprises:
a mounting plate mounted to the lid, said mounting plate configured to pivotably mount the mechanical arm and to mount the spring.

6. The video message delivery system according to claim 1, wherein the video message comprises a plurality of video images.

7. The video message delivery system according to claim 1, further comprising a sound producing device and wherein the circuit is configured to announce an audio message via the sound producing device when the video message is displayed.

8. The video message delivery system according to claim 7, wherein the sound producing device is at least one speaker.

9. The video message delivery system according to claim 7, wherein the circuit is configured to repeat the display of the video message and the announcement of the audio message.

10. The video message delivery system according to claim 9, wherein the circuit is configured to stop the display of the video message and the announcement of the audio message when the light sensor does not sense light entering the interior of the body.

11. The video message delivery system according to claim 1,
wherein the circuit comprises a memory and a processor, wherein the memory comprises a program and the processor is configured to cause the video display to display the video message based on the program.

12. The video message delivery system according to claim 11, further comprising a battery configured to provide said electrical power.

13. The video message delivery system according to claim 1, wherein the body comprises an enclosed surface, and at least part of the enclosed surface is dimensioned to be spaced from an inner surface of the container shell for providing a space between the container shell and the body, said space dimensioned to be filled with a liquid.

14. The video message delivery system according to claim 1, wherein the tab is a stay-on tab and the tab opening mechanism is a stay-on tab opening mechanism.

15. The video message delivery system according to claim 1, wherein the circuit is configured to repeat the display of said video message.

16. The video message delivery system according to claim 15, wherein the circuit is configured to stop the display of the video message when the light sensor does not sense light entering the interior of the body.

17. The video message delivery system according to claim 1, wherein the light sensor is a light sensor switch.

18. The video message delivery system according to claim 1, wherein the lid is the same as a lid of a product container that contains product.

19. The video message delivery system according to claim 1, further comprising a prize holder configured to store a prize award, the prize holder configured to release the prize award when the tab opening mechanism causes the opening to be revealed.

20. A simulated product container comprising:
a container shell having an outer surface substantially identical in appearance to a product bearing shell of a product container normally employed for a product, and having an interior surface configured for providing the simulated product container with a sound, weight and feel of the product normally contained therein;
a video message delivery system comprising:
a body dimensioned for insertion into an open end of the container shell;
a lid disposed on the body, the lid configured to have
an opening,
a tab having a first tab position to conceal the opening and operable to reveal said opening and thereby to allow light to enter into an interior of the body through the opening, and
a tab opening mechanism configured to cause the tab to move from the first tab position into the interior of the body so as to reveal said opening;
a video display disposed in the interior of the body,
a circuit configured to receive of electrical power and configured to display a video message on the video display, and
a light sensor configured to sense light entering the interior of the body and to cause the circuit to display a video message on the video display in response to light entering the interior of the body; and
means positioned in a space between an interior surface of the container shell and an outer surface of the body for providing the simulated product container with the sound, weight and feel of a product normally contained therein.

21. The simulated product container according to claim 20, further comprising a tab deflection mechanism having a mechanical arm pivotably mounted in the interior of the body, the mechanical arm configured to deflect the tab to a second tab position by contacting the tab when the tab is in the interior of the body so as to provide for a substantially unobstructed view of the video message on the video display through said opening.

22. The simulated product container according to claim 21, wherein the tab deflection mechanism further comprises a spring disposed in relationship to the mechanical arm, the spring configured to provide a force to the mechanical arm so as to deflect the tab to the second tab position and maintain the tab in said second position.

23. The simulated product container according to claim 22, wherein the mechanical arm is operable in a first arm position and a second arm position to deflect the tab to the second tab position, said tab deflection mechanism further comprising:
a mechanical stop configured to keep the mechanical arm in the first arm position when the tab is in the first tab position, wherein the tab opening mechanism is configured to cause the mechanical arm to disengage from the mechanical stop so as to allow the mechanical arm to move from the first arm position to the second arm position when the tab opening mechanism causes the tab to move from the first tab position into the interior of the body.

24. The simulated product container according to claim 23, wherein the tab deflection mechanism further comprises:
a mounting plate mounted to the lid, said mounting plate configured to pivotably mount the mechanical arm and to mount the spring.

25. The simulated product container according to claim 20, wherein the video message comprises a plurality of video images.

26. The simulated product container according to claim 20, further comprising a sound producing device and wherein the circuit is configured to announce an audio message via the sound producing device when the video message is displayed.

27. The simulated product container according to claim 26, wherein the sound producing device is at least one speaker.

28. The simulated product container according to claim 26, wherein the circuit is configured to repeat the display of the video message and the announcement of the audio message.

29. The simulated product container according to claim 28, wherein the circuit is configured to stop the display of the video message and of the announcement of the audio message when the light sensor does not sense light entering the interior of the body.

30. The simulated product container according to claim 20,
wherein the circuit comprises a memory and a processor, wherein the memory comprises a program and the processor is configured to cause the video display to display the video message based on the program.

31. The simulated product container according to claim 30, further comprising a battery configured to provide said electrical power.

32. The simulated product container according to claim 20, wherein the body comprises an enclosed surface, and at least part of the enclosed surface is dimensioned to be spaced from an inner surface of the container shell for providing a space between the container shell and the body, said space dimensioned to be filled with a liquid.

33. The simulated product container according to claim 20, wherein the tab is a stay-on tab and the tab opening mechanism is a stay-on tab opening mechanism.

34. The simulated product container according to claim 20, wherein the circuit is configured to repeat the display of said video message.

35. The simulated product container according to claim 34, wherein the circuit is configured to stop the display when the light sensor does not sense light entering the interior of the body.

36. The simulated product container according to claim 20, wherein the light sensor is a light sensor switch.

37. The simulated product container according to claim 20, wherein the lid is the same as a lid of a product container that contains product.

38. The simulated product container according to claim 37, wherein the container shell is the same as a container shell of a product container that contains product.

39. The simulated product container according to claim 20, wherein the container shell is the same as a container shell of a product container that contains product.

40. The simulated product container according to claim 20, further comprising a prize holder configured to store a prize award, the prize holder configured to release the prize award when the tab opening mechanism causes the opening to be revealed.

41. A method for displaying a video message inside a simulated product container comprising:
moving a tab formed in a lid of the simulated product container so as to reveal an opening in the lid;
sensing light entering the interior of the simulated product container and in response thereto, generating a video message for viewing through the opening formed in the lid.

42. The method according to claim 41, wherein the moving of the tab so as to reveal the opening in the lid causes the tab to enter into an interior of the simulated product container, the method further comprising deflecting the tab after the tab has entered into the interior of the simulated product container so as to maintain the tab in a tab position so as to allow for unobstructed viewing of the video message on the video display through the opening.
